(19) United States
(12) Patent Application Publication
(10) Pub. No.: US 2006/0253477 A1
(43) Pub. Date: Nov. 9, 2006

(54) Automated data collection and management system

(76) Inventor: Ramiro Mendes Maranhao, Sao Paulo (BR)

Correspondence Address: LUCAS & MERCANTI, LLP, 475 PARK AVENUE SOUTH, 15TH FLOOR, NEW YORK, NY, 10016, US

(21) Appl. No.: 11/248,917

(22) Filed: Oct. 12, 2005

Related U.S. Application Data
(60) Provisional application No. 60/618,029, filed on Oct. 12, 2004.

(51) Int. Cl. G06F 7/00

(52) U.S. Cl. 707/100

(57) ABSTRACT

Employing an automated data collection portable equipment such as a palm top or similar equipment, in addition to a central computer, which includes a database where the captured information is stored through said portable electronic equipment, and such data transfer may occur by means of cable, connection fixed bases, infra-networks or by means of wireless transmissions, and such database shall be operated by a software, which shall receive the unloaded data and shall perform the correlations with the parameters preset in the system, on a systematic and accurate manner, generating statistical reports and electronic spreadsheets, whose results may be automatically made available, aiming at a better adjustment of people's movement in commercial establishments and others.

### CROSS REFERENCE TO RELATED APPLICATION

This application is entitled to the benefit of U.S. Provisional Patent Application Ser. No. 60/618,029, filed Oct. 12, 2004. Such application is incorporated herein by reference.

### STATEMENT REGARDING FEDERALLY-SPONSORED RESEARCH OR DEVELOPMENT

Not applicable.

### FIELD OF THE INVENTION

The present invention relates to an auditing system, and, more specifically, in commercial establishments' audits, both for individual shops and for a group of shops, such as shop networks, commercial centers and shopping malls; it may also be adapted to be used in franchise systems, airports, highways and others as well. BACKGROUND OF THE INVENTION

Various means aiming at controlling the movement of people in places with large demographic concentration and, more specifically, in commercial centers, where the major activities are related to visitors' personal interests and where the merchants of the most varied market segments should be able to provide full compliance of such interests, not only regarding the prompt supply of goods and/or services, but especially to guarantee the safety and well-being of such visitors while they remain within the premises of the shops or the commercial center, are already well known by the state of the technique.

As it is known, commerce is segmented in several industries, and they are grouped according to the requirements and the needs of serving the consumer public, and in that respect, the business potential of a certain commercial outlet shall serve as a parameter to establish several criteria, not only for the specific operation of such sales outlet, but also for the commercial environment as a whole, from the setting of proper amounts for space leasing to the very shop operating system, as regards the goods supply, the establishment of a price policy to be used, and the application of promotions, among others.

Today, all methods used to control people movement in commercial centers are aimed only at measuring the monthly sales of each shop, with the sole purpose of setting the amount of its lease, according to its sales turnover and its commercial activity type, however, the major inconvenience noticed in such methods is related to the fact that the data gathering is made in handwriting form for subsequent assessment, which besides being an extremely slow activity, both in the collection and in the transcription of such data, is subject to several inaccuracies, due to the risk of losing or tampering of the information upon its transfer to the central computer that shall perform the analysis of the researched data.

### SUMMARY OF THE INVENTION

This AUTOMATED DATA COLLECTION AND MANAGEMENT SYSTEM uses an automated portable data collection equipment such a palm top or similar equipment, in addition to a central computer, which includes a database where the information captured through said electronic portable equipment shall be stored; such data transfer may occur by means of cable, fixed connection bases, infra-networks, or by means of wireless transmissions, and such database shall be operated by a software, which shall receive the unloaded data and shall perform the correlations with the parameters preset in the system, on a systematic and accurate manner, generating statistical reports and electronic spreadsheets, whose results may be automatically made available aiming a better adjustment of the people's movement in commercial establishments and others.

With the purpose of overcoming all inconveniences resulting from such techniques, the AUTOMATED DATA COLLECTION AND MANAGEMENT SYSTEM proposed herein was planned, which consists in the gathering and in recording of data related to the movement of people in commercial outlets, using a palm top or similar equipment platform application, with the capacity of being coupled to cables, fixed connection base, infra-networks or wireless transmission, so that all gathered information is transferred to a database properly installed and set-up in a central computer, in which correlations of the information gathered and the temporal and statistical parameters preset in the system shall be performed, with great reliability, safety and promptness, thus, providing a low procedure cost, creating an improvement in the control and follow-up of people movement in commercial shops, also allowing the departments in charge of the operation control of a single shop or even of a commercial center, to adopt, in real time, all measures required to ensure comfort, wellbeing and safety of visitors, including the optimization of the physical space, both in the shop and in the commercial center, in order to meet such purposes, which shall be made with the aid of a series of reports and electronic spreadsheets of the obtained results, which shall be automatically made available for consultations, aiming at adjusting the operation not only of the sales outlet, but also of the commercial center as a whole.

Thus, the AUTOMATED DATA COLLECTION AND MANAGEMENT SYSTEM proposed herein is intended to provide a system that allows the instant follow-up of the movement of people in a single sales outlet or in a set of shops, aiming at adjustment of their operation in order to meet the visitor's interests, not only as regards the supply of the goods searched, but also the comfort and wellbeing conditions of such visitor during his/her stay within the sales outlet or in the commercial center as well, and which includes two interactive modules, the first being one a data collection module where the registrations and the records of the data representing the movement of people in a sales outlet or in commercial center shall be performed, and that includes personal data, both from buyers and their attendants as well, such as sex and age range, besides data regarding the operation of the sales outlet in itself, such as the shop occupation, the condition of the goods exhibition and/or the lack of goods, the service time, the performance or non-performance of the sale, the waiting time to make the payment, among others, however, the gathering of such data shall be performed with the aid of an application installed in a portable electronic equipment such as a palm top, which shall perform the immediate transfer of data by means of cable, fixed connection base, infra-networks or wireless transmission to the second system module, which includes a PC provided with a database, where such gathered data shall be handled, with the creation of reports and electronic spreadsheets, which shall be automatically made available for consultation, in order to suit the operation not only regarding the sale outlet, but also the commercial center as a whole.

### BRIEF DESCRIPTION OF THE DRAWINGS

In order to better understand the AUTOMATED DATA COLLECTION AND MANAGEMENT SYSTEM proposed herein, we refer to the enclosed drawings, as follows:

FIG. 1—Shows the general operation block diagram of the automated data collection and management system proposed herein;

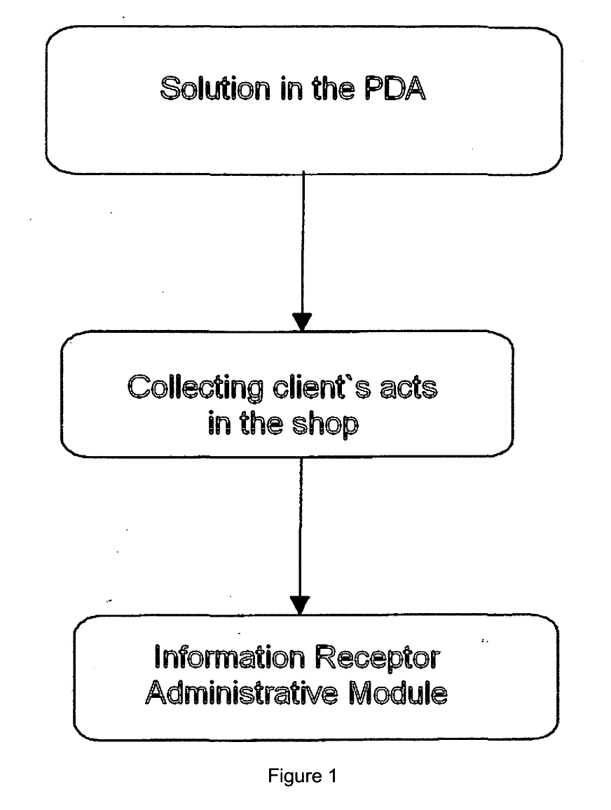

FIG. 2—Shows the general operation block diagram of the information reception module;

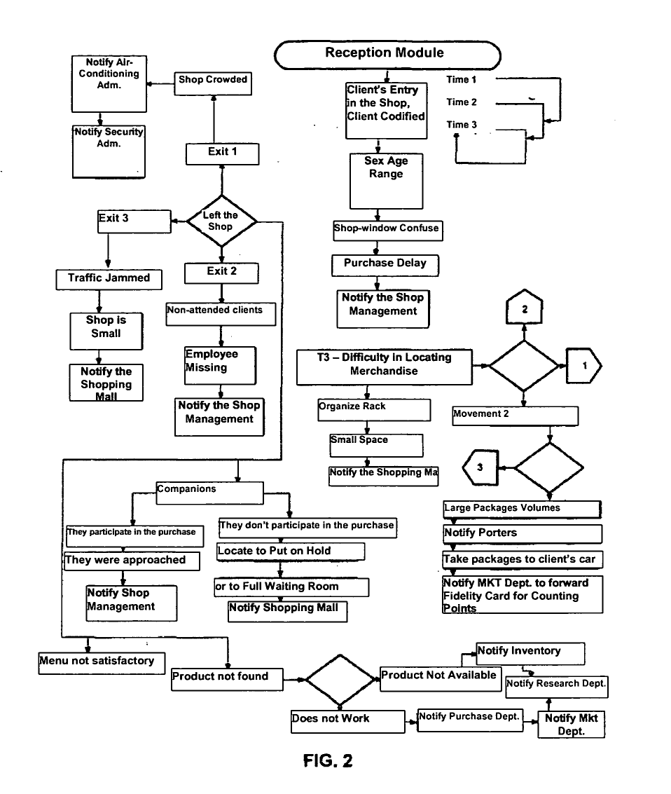

FIG. 3—Shows the block diagram of the occurrences provided for in the information-receiving module;

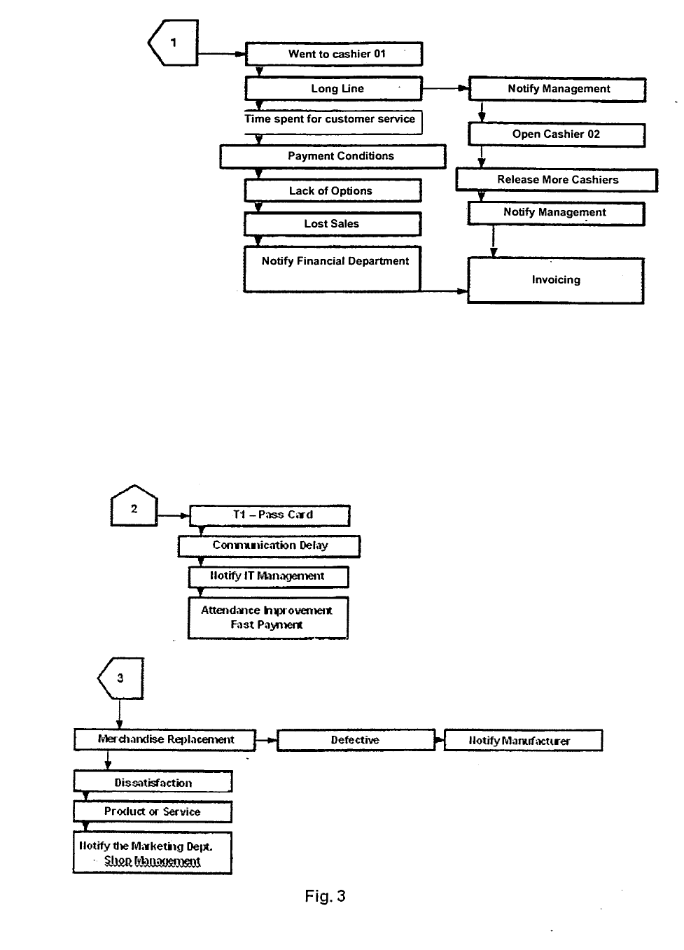

FIG. 4—Shows the block diagram of procedures visualization in the portable electronic equipment;

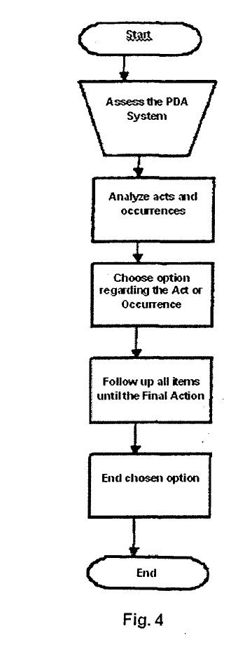

FIG. 5—Shows the block diagram of procedures visualization in the information-reception module.

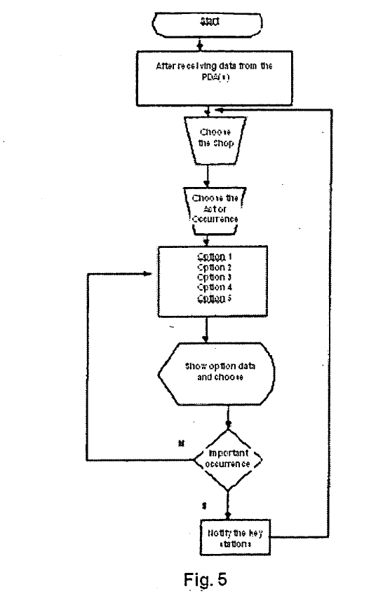

### DETAILED DESCRIPTION OF THE INVENTION

According to the description shown in the attached figures, the AUTOMATED DATA COLLECTION AND MANAGEMENT SYSTEM proposed herein uses a portable electronic equipment, such as a palm top or similar equipment, through which the data are gathered and immediately transferred by means of cable, fixed connection bases, infra-networks or wireless transmissions to the database properly installed and setup in a central computer, in which the correlations of the gathered information with the temporal and statistical parameters preset in the system shall be performed, in order to allow the electronic data transcription, and such data are received in the information-receiving module, as a function of the portable electronic equipment operator input, which shall monitor the behavior of all visitors, from their entry in a sales outlet, which shall be referred to as “client shop” for the system purposes, taking into account the time spent between each visitors' entry input; also, regarding such visitor's entry information, his/her sex shall also be identified, as well as his/her age rate, and if he/she is or not with someone else; from such data, the system may manage the instant and average occupation of the sale outlet, thus, setting the hours and/or days with the largest occupancy, in order to allow, for example, the sale outlet manager or the commercial center administration to provide the adequacy of the environment air conditioning within the shop, or to foresee the requirement of increasing the safety and surveillance systems, thus, allowing also that a selective programming of the promotional events is made, in order to take advantage of the periods in which the shops are mostly occupied, or even indicating both for the shop manager and for the commercial center administration, the requirement of expanding the physical space of such shop; upon the visitor's exit, an input shall also be generated in the system, which shall be related to an identification of reason of his/her exit, where it may stated, for example, that the shop was crowded, which, in view of such occurrence frequency, may indicate both for the shop management and for the commercial center administration, the requirement of expanding its physical space, or if the exit was motivated by a lack of attendance, which may indicate to the shop management the need of increasing the number of employees, or still if such exit was motivated by a difficulty of locating the desired good, and in that case, the system should state if such location difficulty was due to the improper organization of the goods within the shop, or if the good was not found, which may indicate to the shop management the need of reorganizing its internal space, the communication so that the purchase sector take steps to replace the good that is lacking in the inventory, or still, the identification of a good the shop does not operate with; it may also show to the commercial center administration, the need of expanding the shop physical space, the system shall also create an input when for example, the visitor's entry is not aimed at buying, but rather at replacing goods, and in such situation the reason of the replacement shall be identified, which may establish that the merchandise presents a flaw, which shall show to the shop management the need of contacting the manufacturers or the supplier, or still, if the merchandise is not satisfactory, which shall show to the shop management the need of replacing the merchandise when the visitor arrives in the cashier an input is created, and then the system starts to monitor the time spent so that the visitor performs the payment for the purchase, which should be contained within limits preset in the system, and in case such limits are exceeded, the sale outlet may require the opening of other cashiers, or still the necessity of expanding the payment spots; as to the attendance, an input shall be created that will show the payment form, which shall present to the sale outlet management the preferred payment conditions for those who buy at that shop, and in the case of electronic payments, the system shall start to monitor the time spent so that the service administrators are attended, which may indicate to the shop management or even to the commercial center administration, the need of a better adequacy of the information transfer means, and once the sale is made, an input that shall state the profile of the performed sale shall be created, which may present the sale outlet management the necessity of making porters available to help in the goods transportation, besides gathering data for the forwarding of fidelity cards, as well as inclusion in the points counting system.

To summarize, the present invention relates to an AUTOMATED DATA COLLECTION AND MANAGEMENT SYSTEM, which is provided with meaningful advantages regarding the conventional systematic, mainly as a function of its operating coverage, through which it is possible to monitor all occurrences that may be checked not only in a single shop, but in a commercial center as well, which shall allow the optimization of its operation; however, the description presented herein is only an example, and changes may be admitted as included in its scope, as long as they are included within the same inventive principle.

1) AUTOMATED DATA COLLECTION AND MANAGEMENT SYSTEM, is characterized by the fact that a portable electronic equipment of the palm top or similar type shall be used, through which all data is collected and immediately transferred by means of cable, fixed connection base, infra-networks or wireless transmission, to the database properly installed and setup in a central computer, in which the correlations of the information gathered with the temporal and statistical parameters preset in the system, in order to allow the electronic transcription of data, such data being received in the information-receiving module, in view of the portable electronic equipment operator input, which shall monitor the behavior of all visitors in a shop or in a commercial center.

2) AUTOMATED DATA COLLECTION AND MANAGEMENT SYSTEM, according to the claim 1, is characterized by the fact that upon the entry in a shop, an input is generated in the portable electronic equipment, which shall take into account the time spent between each visitor's entry input, and that visitor entry information is related to the visitor's sex, age rate and if he/she is served or not, and from such data, the system may manage the instant and average occupancy of the shop, thus, setting hours and/or days of major occupancy, in order to allow, for example, that the shop management or that the commercial center administration may proceed the adequacy of the environment air conditioning within the shop, or to foresee the need of increasing the safety and surveillance systems, also allowing to make a selective scheduling of promotional events, in order to take advantage of the shop's major occupation periods, or even to show, both to the shop management and to the commercial center administration, the need of expanding the physical space of such sale outlet.

3) AUTOMATED DATA COLLECTION AND MANAGEMENT SYSTEM, according to the claim 1, is characterized by the fact that upon the visitor's exit, an input shall also be generated in the system, which shall be related to an identification of the reason of his/her exit, where it may be shown, for example, that the sale outlet was crowded, which, due to this occurrence frequency, may show both to the shop management and to the commercial center administration, the need of expanding its physical space, or if the exit was motivated by a lack of attendance, which may show to the shop management the necessity of increasing the number of employees, or still if such exit was motivated by the difficulty of locating the desired good, whereas in such situation, the system should show if such place difficulty was due to the improper organization of the goods within the shop or if the merchandise was not found, which may show to the shop management the need of reorganizing its internal space, the communication for the purchase sector to take the steps for the replacement of the good missing in the inventory, or still the identification by a merchandise the sale outlet has does not operate with, and it also may show, for the commercial center administration, the need of expanding the sale outlet physical space.

4) AUTOMATED DATA COLLECTION AND MANAGEMENT SYSTEM, according to the claim 1, is characterized by the fact of the system also generating an input when for example, the visitor entry is not intended for a purchase, but rather for a replacement, and the reason of replacement shall be identified in such situation, which may establish that the merchandise presents a flaw, which shall show to the shop management the need of contacting the manufacturer or supplier, or still if the merchandise is not satisfactory, which shall show to the shop management the need of the merchandise replacement.

5) AUTOMATED DATA COLLECTION AND MANAGEMENT SYSTEM, according to the claim 1, is characterized by the fact that when the visitor arrives at the cashier, an input is generated, and the system starts then to monitor the time spent so that the visitor performs the payment for the purchase, which shall be contained within the preset limits in the system, which in case such limits are exceeding, may show to the shop management, the need of opening new cashiers, or even the necessity of expanding the payment spots.

6) AUTOMATED DATA COLLECTION AND MANAGEMENT SYSTEM, according to the claim 1, is characterized by the fact that upon the service being rendered, an input shall be generated which shall show the payment form, which will show to the shop management the preferred payment conditions for those attending that shop, and in the case of electronic payments, the system shall start to monitor the time spent for the service of the service managers, which may show to the shop management or even to the commercial center administration, the need of a better adequacy of the information transfer means.

7) AUTOMATED DATA COLLECTION AND MANAGEMENT SYSTEM, according to the claim 1, is characterized by the fact that once the sale is made, an input shall be generated that will show the profile of the purchase performed, which may show to the shop management the need of making porters available to help in the transportation of goods, besides gathering data for the forwarding of fidelity cards, as well as the inclusion in the point counting system.
